(19) United States
(12) Patent Application Publication
(10) Pub. No.: US 2011/0303042 A1
(43) Pub. Date: Dec. 15, 2011

(54) INDUSTRIAL ROBOT

(75) Inventors: XIAO-PENG PAN, Shenzhen City (CN); HUA-SHUAI WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO.,LTD., Shenzhen City (CN)

(21) Appl. No.: 12/953,752

(22) Filed: Nov. 24, 2010

(30) Foreign Application Priority Data
Jun. 10, 2010 (CN) 201010195164.6

(51) Int. Cl. B25J 17/00

(52) U.S. Cl. 74/490.05

(57) ABSTRACT

An industrial robot includes a first link, a second link, and a joint connecting the first and second links. The joint includes a main body coupled to the first and second links, a first actuator mounted on the main body to rotate the first link, a second actuator to rotate the main body relative to the second link, a number of cables connected to the second actuators, a protective cover secured to the main body to receive the first and second actuators and the cables, and a number of fasteners fixing the protective cover to the main body.

### BACKGROUND

1. Technical Field

The present disclosure generally relates to robotic technologies, and particularly, to an industrial robot.

2. Description of Related Art

A commonly used industrial robot includes a base anchored to a surface and a plurality of links arranged in series. The links of such an industrial robot are connected by joints to allow rotational motion or translational displacement. Each joint includes one or more electric motors to drive the corresponding links, and a plurality of cables connecting the electric motors to a power supply and/or a controller activating and deactivating the electric motors. However, the cables are usually exposed to the external environment. During the movement of the links, the cables may be drawn and/or come into contact with other components of the industrial robot. As a result, the cables may be unduly damaged and the controller may raise the alarm and deactivate the corresponding electric motor, thus disturbing the normal operation of the industrial robot.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of one embodiment of an industrial robot including a joint provided with a protective cover.

FIG. 2 is a partial, exploded, isometric view of the industrial robot of FIG. 1.

FIG. 3 is an isometric view of the protective cover in FIG. 1.

### DETAILED DESCRIPTION

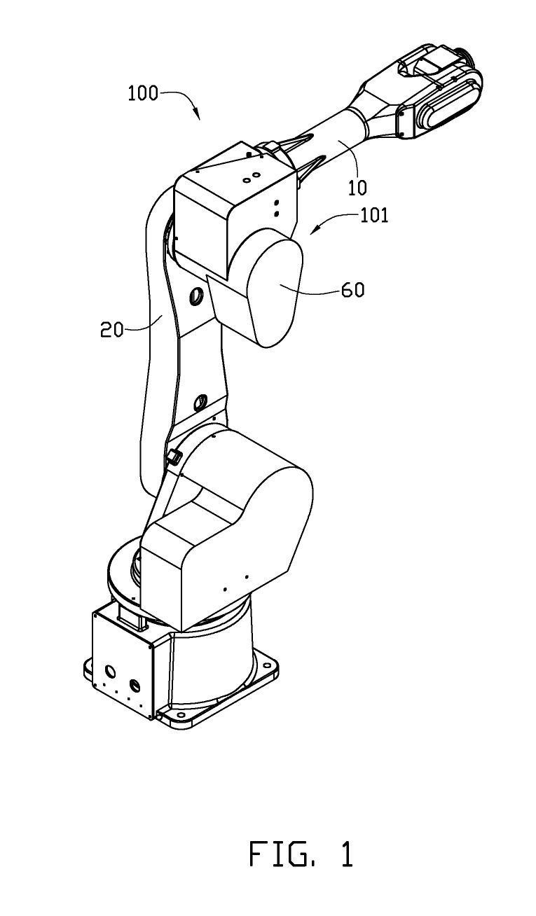

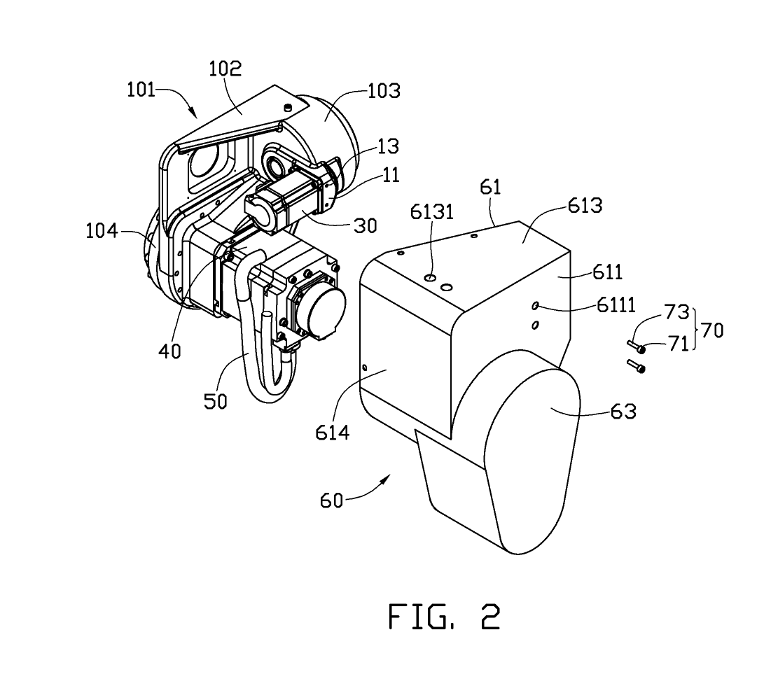

Referring to FIGS. 1 and 2, one embodiment of an industrial robot 100 includes a first link 10, a second link 20, and a joint 101 connecting the first and second links 10, 20.

The joint 101 includes a main body 102 coupled to the first and second links 10, 20, a first actuator 30 to rotate the first link 10, a second actuator 40 to rotate the joint 101, a plurality of cables 50 connected to the second actuator 40, a protective cover 60 secured to the main body 102 to receive the first and second actuators 30, 40, and the cables 50, and a plurality of fasteners 70 to fix the protective cover 60 to the main body 102. In the illustrated embodiment, the industrial robot 100 may be a six-axis robot. The cables 50 can be connected to a supply power and/or a controller (not shown) to transmit signals between the controller and the second actuator 40.

The main body 102 includes a first connecting portion 103 driven by the first actuator 30 and a second connecting portion 104 driven by the second actuator 40. The first connecting portion 103 is coupled to the first link 10, and the second connecting portion 104 to the second link 20. The first connecting portion 103 has a positioning surface 11 connected to the protective cover 60. The positioning surface 11 defines a plurality of positioning holes 13 to receive the fasteners 70.

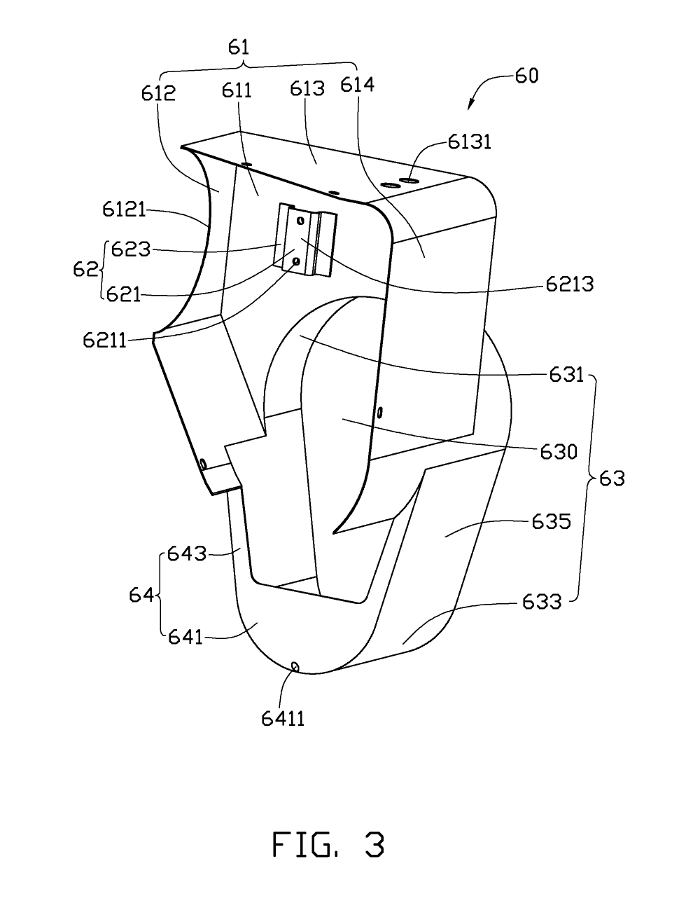

Referring also to FIG. 3, the protective cover 60 includes a first receiving portion 61, a fixing member 62 attached to the inner surface of the first receiving portion 61, a second receiving portion 63 integrally formed with the first receiving portion 61, and a shield portion 64 partially covering the second receiving portion 63.

The first receiving portion 61 includes a bottom surface 611, a first side surface 612, a second side surface 613, and a third side surface 614 extending from the edges of the bottom surface 611. The surfaces 611, 612, 613, 614 cooperatively define a receiving chamber (not labeled) to receive the first actuator 30. The bottom surface 611 defines a plurality of assembly holes 6111 to allow the fasteners 70 to pass through. The first side wall 612 defines a cutout 6121 to match the outer profile of the first connecting portion 103, thus reducing the gap between the protective cover 60 and the main body 102. The second side surface 613 defines a plurality of connecting holes 6131 to allow air conduits or the like to pass through into the protective cover 60.

The fixing member 62 includes a fixing portion 621 and two rims 623 extending from opposite sides of the fixing portion 621. The fixing portion 621 defines a plurality of fixing holes 6211 corresponding to the assembly holes 6111, and has a contact surface 6213 to resist the main body 102. The fixing member 62 can be attached to the bottom surface 611 by welding, threaded fastener, or adhesive, and is separated a predetermined distance from the bottom surface 611.

The second receiving portion 63 includes a bottom surface 630, a first convex portion 631 connected to the bottom surface 611 of the first receiving portion 61, a second convex portion 633 opposite to the first curved portion 631, and a connecting portion 635 connecting the first and second convex portions 631, 632. The bottom surfaces 611, 630 are substantially parallel, and the first and second convex portions 631, 632, and the connecting portion 635 extend from the edges of the bottom surface 630. The diameter of the first convex portion 631 exceeds that of the second convex portion 633.

The shield portion 64 includes a first shield portion 641 and two second shield portions 643 extending from opposites sides of the first shield portion 641. The shield portion 64 can be welded, fastened, or adhered to the second receiving portion 63. In this illustrated embodiment, the shield portion 64 covers the second convex portion 633. The second shield portions 643 connect the connecting portion 635 and the first and third side surface 612, 614 of the first receiving portion 61, respectively. The shield portion 64 further defines a drain hole 6411 to drain waste materials such as waster water and oil in the protective cover 40. The drain hole 641 is positioned on the bottom of the shield portion 64, to drain the waster materials in the second convex portion 633.

Each fastener 70 includes a head portion 71 and a bar 73. The protective cover 60 is secured to the first connecting portion 103 by the fasteners 70. The diameter of the head portion 71 is less than that of the assembly hole 6111 and exceeds that of the fixing hole 6211, such that the fastener 70 can pass through the assembly hole 6111 and be received in the protective cover 60. Therefore, the fasteners 70 are received in the protective cover 60 without extending therefrom, and the industrial robot 100 has a unified and uncluttered appearance.

During assembly, the protective cover 60 is secured to the main body 102 with the first actuator 30 received in the first receiving portion 61, and the second actuator 40 and cables 50 in the second receiving portion 63. The second actuator 40 and part of the cables 50 are received in the first convex portion, and the other parts of the cables 50 are received in the second convex portion 633. The contact surface 6213 of the fixing member 62 resists the positioning surface 11 of the first connecting portion 103. The fixing holes 622 correspond to the positioning holes 13. The fasteners 70 are passed through the assembly hole 6111 and received in the protective cover 60, and the bars 73 of the fasteners 70 are received in the fixing holes 6211 and fastened into the positioning hole 13, thus fixing the protective cover 60 with the main body 102.

In the industrial robot 100 disclosed, the protective cover 64 not only protects the cables 50 from the external environment and prevent damage to the cables 50 during movement of the industrial robot 100, but also strengthens the protective cover 60, thus avoiding deformation thereof.

In other embodiments, the fixing member 62 can be omitted, wherein the bottom surface 611 of the protective cover 60 defines a recess portion. The recess portion defines a plurality of assembly holes 6111 such that the fasteners 70 can be received in the recess portion without affecting the appearance of the industrial robot 100.

It is believed that the present embodiments and their advantages will be understood from the foregoing description, and it will be apparent that various changes may be made thereto without departing from the spirit and scope of the disclosure or sacrificing all of its material advantages.

What is claimed is:

1. An industrial robot comprising:
a first link;
a second link; and
a joint connecting the first and second links, the joint comprising:
a main body coupled to the first and second links;
a first actuator mounted on the main body to rotate the first link;
a second actuator to rotate the main body relative to the second link;
a plurality of cables connected to at least one of the first and second actuators;
a protective cover secured to the main body to receive the first and second actuators, and the cables; and
a plurality of fasteners fixing the protective cover to the main body.

2. The industrial robot of claim 1, wherein the protective cover comprises a first receiving portion, a second receiving portion integrally formed with the first receiving portion, and a shield portion at least partially covering the second receiving portion; the first actuator is received in the first receiving portion, and the second actuator is received in the second receiving portion.

3. The industrial robot of claim 2, wherein the first receiving portion comprises a bottom surface, a first side surface, a second side surface, and a third surface extending from edges of the bottom surface; the bottom surface, the side surfaces cooperatively define a receiving chamber to receive the first actuator.

4. The industrial robot of claim 3, wherein the bottom surface of the first receiving portion defines a plurality of assembly holes to allow the plurality of fasteners to pass through.

5. The industrial robot of claim 4, further comprising a fixing member attached to the bottom surface of the first receiving portion, wherein the fixing member defines a plurality of fixing holes, and the plurality of fasteners engages in the fixing holes and fastens into the main body.

6. The industrial robot of claim 5, wherein the fixing member comprises a fixing portion and two rims extending from opposite sides of the fixing portion, and the fixing portion has a contact surface resisting the main body.

7. The industrial robot of claim 5, wherein the fixing member is attached to the bottom surface by welding, a threaded fastener, or adhesive.

8. The industrial robot of claim 6, wherein the fixing portion is apart a predetermined distance from the bottom surface.

9. The industrial robot of claim 5, wherein each of the plurality of fasteners comprises a head portion and a bar, the diameter of the assembly hole exceeds that of the head portion, and the diameter of the fixing hole is less than that of the head portion.

10. The industrial robot of claim 3, wherein the first side wall defines a cutout to match the outer profile of the main body.

11. The industrial robot of claim 3, wherein the second side surface defines a plurality of connecting holes for air conduits to pass through into the protective cover.

12. The industrial robot of claim 3, wherein the second receiving portion comprises a bottom surface, a first convex portion connected to the bottom surface of the first receiving portion, a second convex portion opposite to the first curved portion, and a connecting portion connecting the first and second convex portions.

13. The industrial robot of claim 12, wherein the shield portion at least partially covering the second convex portion of the second receiving portion.

14. The industrial robot of claim 13, wherein the shield portion is welded to the second receiving portion.

15. The industrial robot of claim 13, wherein the bottom of the shield portion defines a drain hole to drain waste materials in the protective cover.

16. The industrial robot of claim 1, wherein the main body includes a first connecting portion driven by the first actuator and a second connecting portion driven by the second actuator; the first connecting portion is secured to the first link, and the second connecting portion is secured to the second link.

17. The industrial robot of claim 16, wherein the first connecting portion has a positioning surface connected to the protective cover, and the positioning surface defines a plurality of positioning holes in which the plurality of fasteners are received.

18. The industrial robot of claim 1, wherein the protective cover defines a recess portion defining a plurality of assembly holes, and the fasteners are received in the recess portion.

19. An industrial robot comprising:
a first link;
a second link; and
a joint connecting the first and second links, the joint comprising:
a main body coupled to the first and second links;
a first actuator mounted on the main body to rotate the first link;
a second actuator to rotate the main body relative to the second link;
a plurality of cables connected to at least one of the first and second actuators; and
a protective cover fixed to the main body to receive the first and second actuators, and cover the cables, thereby preventing the cables from being exposed to external environment.
